(19) United States
(12) Patent Application Publication
(10) Pub. No.: US 2022/0351225 A1
(43) Pub. Date: Nov. 3, 2022

(54) LOCATION AND DRIVING BEHAVIOR-BASED INCENTIVE SYSTEM

(71) Applicant: WAY INC., Fremont, CA (US)

(72) Inventor: Binumon Thamarashn GIRIJA, Sunnyvale, CA (US)

(73) Assignee: WAY INC., Fremont, CA (US)

(21) Appl. No.: 17/733,878

(22) Filed: Apr. 29, 2022

Related U.S. Application Data
(60) Provisional application No. 63/182,587, filed on Apr. 30, 2021.

(51) Int. Cl. G06Q 30/02; G06Q 40/08; B60W 40/09; G07C 5/00; G06N 3/08

(52) U.S. Cl. CPC G06Q 30/0207; G06Q 40/08; B60W 40/09; G07C 5/008; G06N 3/08

(57) ABSTRACT

The present subject matter refers to a method implemented in a behavior-based risk-profiling system. The method includes receiving at least one of a location and a driving-behavior metric of a user, determining a risk profile of the user by analyzing the received at least one of the location and the driving-behavior metric, and classifying the user based on the determined risk profile. The risk profile indicates a risk associated with a driving behavior.

### RELATED APPLICATION(S)

This application claims priority under 35 U.S.C. § 119(e) of the co-pending U.S. Provisional Patent Application Ser. No. 63/182,587, filed Apr. 30, 2021, and titled “Location and Driving Behavior-Based Incentive System,” which is hereby incorporated herein by reference in its entirety.

### FIELD OF THE INVENTION

The embodiments discussed in the present disclosure are generally related to rewarding incentives. In particular, the embodiments discussed are related to location and driving behavior-based incentive systems and methods.

### BACKGROUND OF THE INVENTION

Vehicle insurance, car insurance, or auto insurance are instruments that are typically designed to cover risk of financial liability or the loss of a motor vehicle that an owner may face if his/her vehicle is involved in an event that results in property or physical damage. Most states and/or countries require a motor vehicle owner to carry some minimum level of liability insurance. When the motor vehicle owner connects with an insurance company to purchase an insurance policy, the insurance company may use actuarial science-based models to assess risk while underwriting the insurance policy. These statistical models may be applied to individual customer profile and other demographic data such as age, gender, address, employment, income, marital status, credit rating, type of vehicle owned, etc., to compute a risk score. The computed risk score may be utilized to determine an insurance premium associated with the insurance policy, the insurance premium being a monthly fee typically paid by the motor vehicle owner(s) to the insurance companies or insurers. However, individual customer behavior patterns are not taken into consideration while quoting the insurance policy.

### SUMMARY OF THE INVENTION

The detailed description is set forth with reference to the accompanying figures. In the figures, the left-most digit(s) of a reference number identifies the figure in which the reference number first appears. The use of the same reference numbers in different figures indicates similar or identical items.

In an aspect, the present subject matter refers to a method implemented in a behavior-based risk-profiling system. The method includes receiving at least one of a location and a driving-behavior metric of a user, determining a risk profile of the user by analyzing the received at least one of the location and the driving-behavior metric, and classifying the user based on the determined risk profile. The risk profile indicates a risk associated with a driving behavior.

In an embodiment, the user is incentivized based on classifying the user, wherein the incentivizing includes communicating at least one recommendation to the user based on the determined risk profile to improve the risk profile; and thereby incentivizing a compliance by the user with the at least one recommendation. Prior to the incentivizing, the determined risk profile is communicated to a remote server followed by receiving a validation of the at least one risk profile from the remote server. The remote server is associated with a service provider maintaining a historical log of the user.

In an embodiment, the determining the risk profile comprises training an artificial neural network (ANN) based on at least one of the gathered location and the at least one driving-behavior metric, and implementing the ANN to predict the risk associated with the driving behavior of the at least one user.

In an embodiment, the at least one location of the user includes a plurality of Global Positioning System (GPS) coordinates at which a vehicle driven by the user is positioned. The driving-behavior metric is received from at least one on-board sensor installed in a vehicle driven by the user.

In an embodiment, the incentivizing the compliance by the user with the at least one recommendation includes proposing the user to avail at least one service related to a plurality of automobile related services and a plurality of non-automobile related services from a corresponding service provider.

In an embodiment, a non-compliance with the at least one recommendation by the user is disincentivized by alerting the user and a service provider.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example of an operating environment in which a location and driving behavior-based incentive system may be utilized in accordance with an embodiment.

FIG. 2 illustrates a signal flow diagram for location and driving behavior-based incentive system in accordance with an embodiment.

FIG. 3 illustrates a signal flow diagram for location and driving behavior-based incentive system in accordance with another embodiment.

FIG. 4 illustrates a block diagram of a server for location and driving behavior-based incentives in accordance with an embodiment.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

Systems have evolved in the insurance industry with advancement in technologies and increased connectivity between devices and/or vehicles or automotive. Customer data may be collected related to driving habits such as but not limited to driving speed, miles driven, hard-braking incidents etc. using various devices/sensors/sub-systems integrated with the vehicles or by other means. In such systems, the collected customer data may be used to provide dynamic risk scoring, which may further be used to set insurance premium. For instance, if a customer claims that a vehicle is usually driven for 100 miles in a month but the actual data associated with the vehicle shows 1000 miles per month, then the insurance premium rate is increased proportionately for the next premium. In another instance, if the actual data from a vehicle reveals that a customer drives in “red zone” frequently, then the driver/customer may have to pay an increased insurance premium. Therefore, there is a penalizing or a negative impact on the customer for an undesirable driving behavior.

There are also other systems where data is collected by an application (“app”) on phone/mobile device of a customer before an insurance premium is set/determined for the customer. For example, an insurer (agent or company) may require the customer to install an app in a mobile device and use it for a predetermined duration such as few weeks. Based on the data or driving behavior metrics collected by the app (and eventually an app server) while the vehicle is being driven, the insurance premium may be set for the customer.

Further, highly computerized and automated feedback systems are evolving in advanced vehicles such as electric vehicles or hybrid vehicles. Such systems in electric vehicles may give feedback on driving behavior. For example, as a user drives, the system may give feedback on different aspects of driving behavior. On the other hand, such systems in hybrid vehicles may give feedback to indicate to a user whether driving is fuel-efficient, green or not, whether acceleration is beyond a threshold so mileage is not optimal etc. In a nutshell, such systems are designed to optimize energy usage and thereby improve mileage of the vehicle.

However, none of the above-mentioned systems reward the drivers in any way for exhibiting safe or good driving behavior over a period of time with an aim to promote better driving skills or good driving behavior among the drivers of vehicles.

The proposed system uses dynamic risk scoring to incentivize individuals to adopt safer and less risky behavior. Particularly, the proposed system will collect location data along with driving behavior data by monitoring driving metrics via either a vehicle mounted device or an application on a user device. The collected location data and driving behavior data may be used to incentivize or benefit the driver/user in case good/safe driving behavior or driving behavior above a set criterion is exhibited by the driver/user. The proposed system focuses on incentivizing the driver/user instead of penalizing thereby positively enforcing a desirable behavior.

Further, the proposed system is designed to give positive feedback for good driving behavior, where the positive feedback may be in form of incentives on a platform that offers auto related services. For example, an application (app) may provide auto related services such as Insurance, Car Parking, Car Wash, Car Fuel filling, and other services. The other services may include but are not limited to fun/adventure activities, movies, dining, transportation, and events. A user who allows the app to collect location data and driving behavior data may be rewarded with incentives in terms of points, discounts, or coupons when the user is determined to exhibit good driving behavior for a predetermined duration. The user may use the points earned, apply the discounts, or use the coupons to redeem benefits related to Car Parking, Car Wash, Car Fuel filling, and other services on the app.

For instance, a user may be labelled as a safe driver or a driver exhibiting good driving behavior based on the collected location data and driving behavior data by the app. The collected location data and driving behavior data of such a user may be forwarded to insurance companies/insurers/agents or fed into insurance company/insurers/agents' servers, to enable the user to avail benefits such as reduced insurance premium at the time of renewal of insurance policy. Alternatively, the user may be provided an option of sharing the collected location data and driving behavior data with the insurance companies/insurers/agents after being observed as a safe driver. Subsequently, subject to the user's consent, the collected location data and driving behavior data may be shared with the insurance companies/insurers/agents to gain the positive impact on the insurance premium.

Certain terms and phrases have been used throughout the disclosure and will have the following meanings in the context of the ongoing disclosure. “App Platform” refers to basic hardware and operating system on which an application runs. “OBD port” refers to an On-Board Diagnostics (OBDs) port that is used to access vehicle's computer i.e., Electronic Control Unit (ECU). OBD port allows a person to determine the status of various vehicle sub-systems and remedy the malfunctions detected within the vehicle. OBD port is mandated in light and heavy-duty vehicles by several governments, including U.S. government, as OBD systems provide self-diagnostic functionality to alert the driver of the vehicle about potential problems that may affect the emission performance of the vehicle. The OBD systems monitor and detect errors that impact engine performance, such as but not limited to fuel systems, Emission Control Systems, Transmission Systems, Vehicle/Speed Idling Controls, Engine Misfires, and other issues related to chassis, vehicle body etc. Modern implementations and applications of the OBD port allow real-time data analysis. “OEM” refers to Original Equipment Manufacturer.

The term “database”, as used herein, may refer to an organized collection of structured information, or data, typically stored electronically in a computer system. “Machine learning (ML)” is a type of artificial intelligence (AI) that allows software applications to become more accurate at predicting outcomes without being explicitly programmed to do so. “Supervised ML” is the type of machine learning in which machines are trained using well “labelled” training data, and on basis of that data, machines predict the output. “Labelled data” means some input data is already tagged with the correct output. “Neural networks” are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters. “Validation data set” is a dataset that provides an unbiased evaluation of a model fit on the training data set while tuning the model's hyperparameters. “Test data set” is a data set used to provide an unbiased evaluation of a final model fit on the training data set. “Deep learning” may refer to a family of machine learning models composed of multiple layers of neural networks, having high expressive power and providing state-of-the-art accuracy.

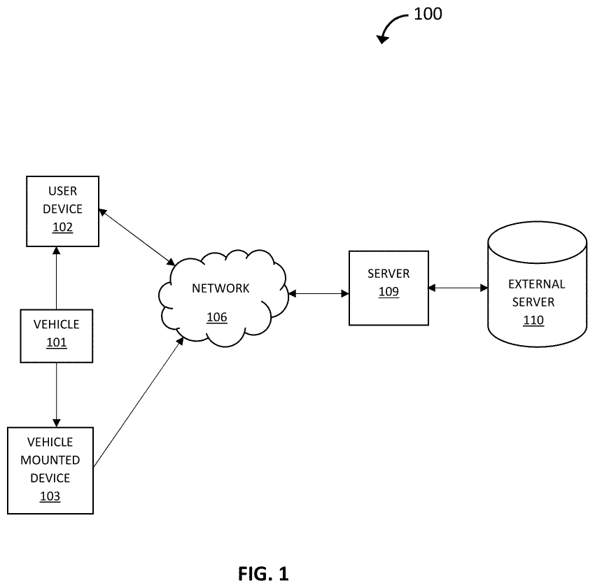

FIG. 1 illustrates an operating environment in which a location and driving behavior-based incentive system may be utilized in accordance with an embodiment of the disclosure. In FIG. 1, an exemplary operating environment 100 is depicted. The exemplary operating environment 100 may include a vehicle 101, a user device 102, a vehicle mounted device 103, a network 106, server 109, an external server 110, and an external source (not shown in figure).

The vehicle 101 may be a vehicle associated with the user device 102. In an embodiment, the vehicle 101 may include an on-board diagnostics (OBDs) port. In an embodiment, the vehicle 101 may be a car driven by a single user. In an embodiment, the vehicle 101 may be a car shared among multiple users.

The user device 102 may be a medium for a user to interact with an app related to auto services downloaded on the user device 102. In an embodiment, the user device 102 may select a service such as auto insurance on the app and interact with the app platform to purchase an auto insurance policy. In an embodiment, the insurance policy purchased by the user on the app may relate to usage-based premium. In an embodiment, the app downloaded on the user device 102 may be used to sense location and driving behavior related metrics. In an embodiment, sensing the location and the driving behavior related metrics may be a service provided by the app separate from the auto insurance related service. In an embodiment, sensing the location and the driving behavior related metrics may be provided as an independent service on an app. In an embodiment, sensing the location and the driving behavior related metrics may be provided as an independent service but linked to the auto related services app for availing incentives when driver exhibits good driving behavior over a predetermined period of time. In an embodiment, the user device 102 may sense or collect location and driving behavior related metrics using in-built sensors without communication or connection with the vehicle 101. The in-built sensors of the user device 102 may include various motion and location sensors such as but not limited to accelerometer, gyroscope, magnetometer, and Global Positioning System (GPS) sensor.

In an embodiment, the location data may be GPS coordinates of each location travelled by the vehicle 101. In an embodiment, a GPS device may be plugged into the OBD port inside the vehicle 101 for collecting the location data. In an embodiment, the location data and the driving behavior data may be collected when a user is driving the vehicle 101. In an embodiment, the collected driving behavior data may be used to detect but not limited to one or more of: how well the user drives, how careful the user is, is the user an aggressive driver, does the user speed occasionally or frequently, does the user accelerate suddenly or not, frequency of sudden acceleration, does the user apply sudden braking or not, frequency of sudden braking, does the user drive through dangerous roads or safe roads, and is the driving speed above allowed speed on roads. In an embodiment, the collected location data and the driving behavior data may be used to assess how risky or aberrant the driving behavior of the user is while driving the vehicle 101.

In an embodiment, the user device 102 may include but is not limited to a mobile device, a smartphone, a personal computer, a laptop, a desktop, a netbook, a tablet, a personal digital assistant (PDA), a touch screen device, a smartwatch, an internet of things (IoT) device, and/or a wearable device.

The vehicle mounted device 103 may be a hardware device/scanner/tool that resides inside the vehicle 101. In an embodiment, the vehicle mounted device 103 may be a hardware device that is compatible with the OBD port and may be plugged into the OBD port to extract vehicle data. In an embodiment, the vehicle mounted device 103 may be a plug-and-play device, which may be plugged into the OBD port of the vehicle 101 to extract location data along with driving behavior data. In an embodiment, the vehicle mounted device 103 may be a built-in hardware device inside the vehicle 101. In an embodiment, the vehicle mounted device 103 may be an OEM device. In an embodiment, the OEM device may be shipped for installation into the vehicle 101 once the user purchases an insurance policy on the auto related services app. In an embodiment, the location data and the driving behavior data may be gathered by monitoring driving metrics via the auto related services app on the user device 102 and/or the vehicle mounted device 103.

The user device 102 may communicate via wireless communication with the network 106, such as the Internet, an Intranet and/or a wireless network, such as a cellular network, a wireless local area network (WLAN) and/or a metropolitan area network (MAN). The wireless communication may use any of a plurality of communication standards, protocols and technologies, such as Long Term Evolution (LTE), LTE-Advanced, Global System for Mobile Communications (GSM), Enhanced Data GSM Environment (EDGE), wideband code division multiple access (W-CDMA), code division multiple access (CDMA), time division multiple access (TDMA), Single-Carrier Frequency Division Multiple Access (SC-FDMA), Orthogonal Frequency Division Multiple Access (OFDMA), Bluetooth, Wireless Fidelity (Wi-Fi) (such as IEEE 802.11a, IEEE 802.11b, IEEE 802.11g and/or IEEE 802.11n) voice over Internet Protocol (VoIP), Wi-MAX, a protocol for email, instant messaging, and/or Short Message Service (SMS).

In an embodiment, the network 106 may facilitate communication between the user device 102 and the server 109 so that the user can seek resources for one or more services on the app platform. In an embodiment, the network 106 may facilitate communication between the vehicle mounted device 103 and the server 109 to analyze the location data and the driving behavior data extracted from the vehicle mounted device 103 plugged into the OBD port of the vehicle 101.

The server 109 includes suitable logic, circuitry, interfaces, and/or code for hosting an app or a website related to auto services that are accessed by user devices. In an embodiment, the server 109 may be communicably coupled with the external server 110. In an embodiment, the server 109 may store data associated with a plurality of users interacting with the app via respective user devices. In an embodiment, the server 109 may be configured to receive the location data and the driving behavior data either from the app on the user device 102 or the vehicle mounted device 103 periodically. In an embodiment, the server 109 may be configured to receive the location data and/or the driving behavior data from the app on the user device 102 and/or the vehicle mounted device 103 periodically.

In an embodiment, the server 109 may analyze the location data and the driving behavior data received periodically from the app on the user device 102 or the vehicle mounted device 103. In an embodiment, based on the analysis of the collected location data and the driving behavior data, the server 109 may categorize a user as safe, moderate risk, or high-risk driver. For example, a user may be determined as a safe driver when the analyzed driving behavior is safe and within predefined limits. Further, a user may be determined as a moderate risk driver when the analyzed driving behavior includes at least one metric above a predefined threshold. Furthermore, a user may be determined as a high-risk driver when the analyzed driving behavior is rash or aberrant.

In an embodiment, the server 109 may implement an artificial neural network (ANN) as part of incorporating Artificial Intelligence (AI) module. The ANN may be trained based on a data set including several values of location data and driving behavior metric received and accumulated over a period of time. The trained ANN thereafter predicts the risk associated with the user. The prediction from the ANN may be validated based on a communication from the external server 110 to determine the risk profile.

In an embodiment, the server 109 may analyze the collected location data and the driving behavior data in real-time to create a risk profile for a user. In another embodiment, the server 109 may analyze the collected location data and the driving behavior data in near real-time to create a risk profile for a user. In yet another embodiment, the server 109 may analyze the collected location data and the driving behavior data in non-real time i.e., using historical data to create a risk profile for a user.

In an embodiment, the users determined to be safe drivers by the server 109 may be provided incentives for promoting safe/good driving. In an embodiment, the incentives may be in form of coins or points on the app platform. Such earned coins or points may be used to redeem benefits related to Car Parking, Car Wash, Car Fuel filling, and other services on the app platform. In an embodiment, the incentives may be discount vouchers on one or more services offered on the app platform. In an embodiment, the incentives may be coupons related to entertainment, food/meal, events etc. which may be used anywhere across a defined region or on applicable online websites.

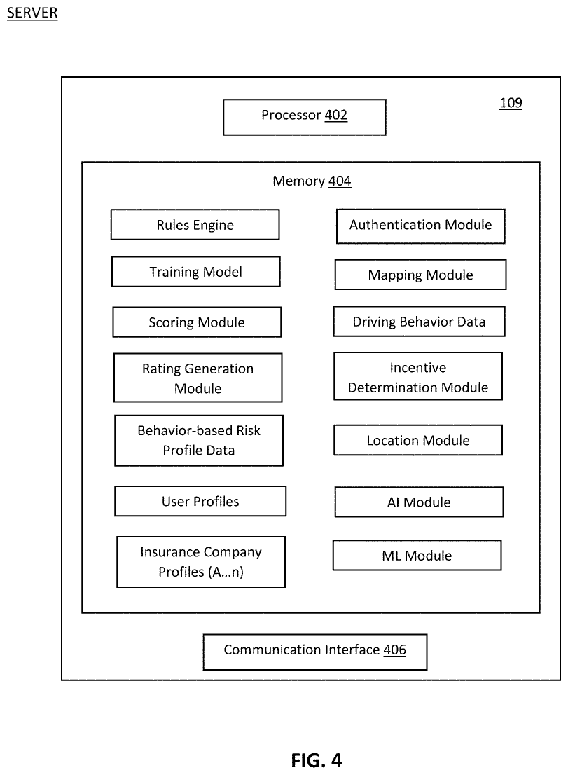

The server 109 may include a plurality of modules that are designed to perform a plurality of functions. The plurality of modules included in the server 109 will be explained later in description of FIG. 4.

The external server 110 may be one or more servers linked to service providers on the app platform. In an embodiment, the external server 110 may be associated with one or more insurance companies that provide insurance related services on the app platform. In an embodiment, the server 109 may determine the risk profile of each user and convey the result of the analysis to the one or more insurance companies via the external server(s) 110. In an embodiment, the risk profiles pertaining to safe drivers or no-risk drivers may be shared with the one or more insurance companies to facilitate a positive impact on the insurance premiums. In an embodiment, a company offering the auto related services via an app may enter into an agreement with the one or more insurance companies to share the collected location data and the driving behavior data of users for underwriting their policies. In an embodiment, the server 109 may share the user data related to the collected location data and the driving behavior data with the one or more insurance companies after user consent.

Further, the external source may be an external database to access user historical data. The user historical data may pertain to motor vehicle records (MVRs), credit history, etc. In an embodiment, the external source may be a repository where MVRs are stored and that may be accessed by the server 109. In an embodiment, the MVRs may be pulled from governmental agencies (such as Department of Motor Vehicle (DMV)) and/or consumer reporting agencies that have access to MVRs by paying the requisite fees. In an embodiment, the MVRs of a particular user may be pulled for certain years, such as but not limited to three years or five years from the time of applying for an insurance policy. In an embodiment, the MVR of a user may be pulled by the service provider such as before and/or at the time of underwriting an insurance policy for the user. In an embodiment, the MVR of the user may be accessed by one or more insurance companies directly while underwriting the policy for the user. In an embodiment, the MVR of the user may be provided by the server 109 to the one or more insurance companies. In an embodiment, the MVR of the user may be accessed by the server 109, and one or more insurance companies before and/or at the time of underwriting the insurance policy for the user. In an embodiment, the MVR of the user may be accessed by the server 109, and one or more insurance companies at the time of or a predetermined time before renewal of an insurance policy of the user.

In an embodiment, the external source may be a repository from where the user credit history may be accessed by the server 109. In an embodiment, the user credit history may be managed by an external credit rating agency and the server 109 may access the user credit history on per user basis. In an embodiment, the user credit history may be accessed before and/or at the time of underwriting an insurance policy for the user.

In an embodiment, the server 109 and the external server 110 may be construed as integrated with each other as a single server 109. While the description of FIG. 1 refers to the first server 109 and the external server 110 as separate devices, in an embodiment, the same shall not be construed as limiting and the description may be expandable to cover a scenario wherein the servers 109, 110 may be construed as integrated with each other as a single user device/server 109. In another embodiment, the server 109 and the external server 110 may be logical/virtual partitions that are segmented from each other via virtual segmentation or any other known segmentation technique.

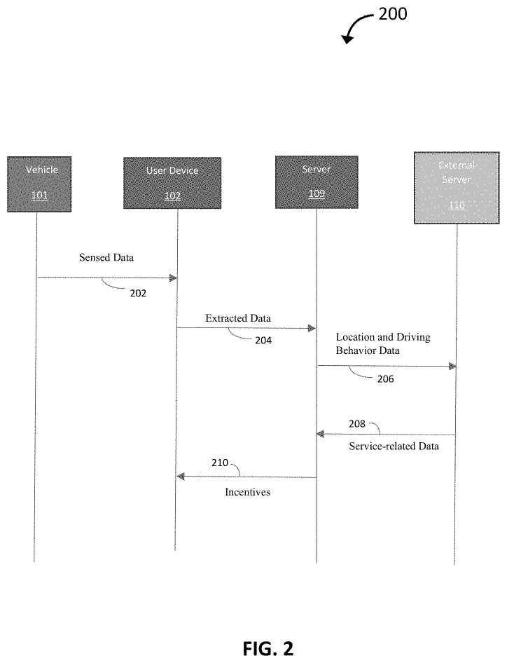

FIG. 2 illustrates a signal flow diagram for location and driving behavior-based incentive system in accordance with an embodiment. In FIG. 2, an exemplary signal flow diagram 200 is disclosed. FIG. 2 will be described in conjunction with terms and description used previously in FIG. 1. The signal flow diagram 200 includes flow of data involving the vehicle 101, the user device 102, the server 109, and the external server 110.

In an embodiment, the user device 102 may be associated with a user who wishes to purchase a service such as auto insurance. The user may download an auto-related services app to purchase the required service for the vehicle 101 associated with the user. In an embodiment, when the user downloads the app on the user device 102 and selects the service such as the auto insurance, a module or a plug-in may be invoked on the app downloaded on the user device 102.

At step 202, when the user drives the vehicle 101, the module or plug-in present on the app of the user device 102 may sense or detect locations where the vehicle 101 is being driven as well as sense or detect driving behavior of the user driving the vehicle 101. In an embodiment, the module or plug-in present on the app of the user device 102 may constantly collect the location data and driving behavior data associated with the driver of the vehicle 101. In an embodiment, the user device 102 may sense or collect location and driving behavior related data using in-built sensors without communication or connection with the vehicle 101. The location of the user includes a plurality of Global Positioning System (GPS) coordinates at which a vehicle driven by the user is positioned. A driving-behavior metric as collected includes, but not limited to, a driving behavior of the user, an alert state of the user, a frequency of over-speeding by the user, a frequency of abrupt acceleration by the user, a frequency of abrupt braking by the user, a frequency of driving upon uneven terrain by the user, and a frequency of driving upon an even terrain by the user.

At step 204, the user device 102 may send the sensed or collected location data and driving behavior data to the server 109. In an embodiment, the user device 102 may send the sensed or collected location data and driving behavior data to the server 109 constantly or after every predetermined interval. In an embodiment, the server 109 may analyze the collected location data and the driving behavior data to determine in real-time or non-real time whether the user being interacted with is a safe driver or not. The server 109 analyzes the received location and the driving-behavior metric to determine a risk profile of the user. The risk profile classifies the user according to a risk associated with a driving-behavior of the user.

In an embodiment, the server 109 may determine incentives for the user associated with the vehicle 101 when the user is determined to be a safe driver based on the collected location data and driving behavior data. In an embodiment, the server 109 may identify certain incentives for users who are safe drivers to promote safe/good driving. In an embodiment, the incentives may be one or more of coins, points, discount vouchers, and coupons. In an embodiment, the incentives may be used to redeem benefits related to Car Parking, Car Wash, Car Fuel filling, and other services on the app platform.

In an embodiment, the server 109 may analyze the collected location data and driving behavior data to create or determine a risk profile of the user. In an implementation, but not limited to, the computing or determining of the risk profile may be construed as creation of the risk profile. The risk profile classifies the user as being a high-risk, moderate risk, or no risk/safe driver. In an embodiment, the server 109 may analyze the collected location data and driving behavior data to accord a risk profile rating to each user based on the created risk profile. The risk profile rating may pertain to a specific rating for no-risk/safe, moderate risk, or high-risk driver. In an embodiment, the server 109 may store the risk profile and the risk profile rating for each user temporarily, for a fixed time period, or permanently. Accordingly, the user is classified based on the risk profile as determined.

At step 206, optionally, the server 109 may send the location data and the driving behavior data of the user to the external server 110. In an embodiment, the location data and the driving behavior data of a particular user may indicate, to the service provider such as one or more insurance companies associated with the external server 110, whether the user is a safe driver or not. In an embodiment, the server 109 may share the location data and the driving behavior data with the external server 110 for only those users who are safe drivers.

At step 208, optionally, based on the received location data and the driving behavior data of the user, the service provider such as one or more insurance companies may send the service-related data to the server 109. Specifically, initially, the server 109 communicates the determined risk profile to a remote server such as the external server 110. Based thereupon, the server 109 receives a validation of the at least one risk profile from the remote server. The remote server is associated with service provider such as a vehicle insurance provider maintaining at least one historical log of the user.

In an embodiment, the one or more insurance companies may modify the service-related data such as terms, conditions, and/or parameters of the insurance policy at the time of renewal. The modified terms, conditions, and/or parameters of the insurance policy may be communicated, by the one or more insurance companies via the external server(s) 110, to the server 109. In an embodiment, based on the location data and the driving behavior data of the user, the one or more insurance companies may modify the terms, conditions, and/or parameters of the insurance policy when the insurance policy opted by the user is based on usage-based premium. In an embodiment, the one or more insurance companies may offer a reduced premium for the users who are determined as safe drivers by the server 109.

At step 210, after optionally receiving the service-related data from the external server 110, the server 109 may incentivize the user or in other words, determine the incentives for the user who exhibits good driving behavior. Specifically, the server 109 communicates at least one recommendation to the user based on the determined risk profile to improve the risk profile of the user, and accordingly incentivizes a compliance by the user with the at least one recommendation. The server 109 incentivizes the compliance by the user with the recommendation by proposing the user a rebate with respect to availing at least one service related to a plurality of automobile related services such as vehicle parking, vehicle-maintenance, fuel filling; and a plurality of activities ancillary thereto. The services may also be a plurality of non-automobile related services related to at least one of recreation, leisure, food, travelling and a plurality of activities ancillary thereto. In other example, the user may be incentivized by allowing the user to avail at least one of a rebate and/or at least one relaxed condition associated with usage of products and services. The user may be proposed reduction in a vehicle insurance renewal. In other scenario, a non-compliance with the at least one recommendation by the user may be disincentivized by the server 109 based on alerting the user and/or a service provider such as an insurance service provider. The alert may be at least one of an increased cost (e.g., increased insurance renewal premium) and at least one additional limitation associated with usage of products and/or services.

The determined incentives may be communicated to the user via the app downloaded on the user device 102. In an embodiment, sending the determined incentives by the server 109 may pertain to forwarding the terms, conditions, and/or parameters of the insurance policy received from the external server 110 to the app on the user device 102.

In an embodiment, after receiving the incentives from the server 109, the app on the user device 102 may display the incentives which may be redeemed by the user. In an embodiment, the incentives may be redeemed by the user in a predefined time. In an embodiment, the incentives may be redeemed by the user subject to terms and conditions specified at the time of receiving the incentives on the app of the user device 102. In an embodiment, the incentives may be provided to the user via a medium other than the app on the user device 102.

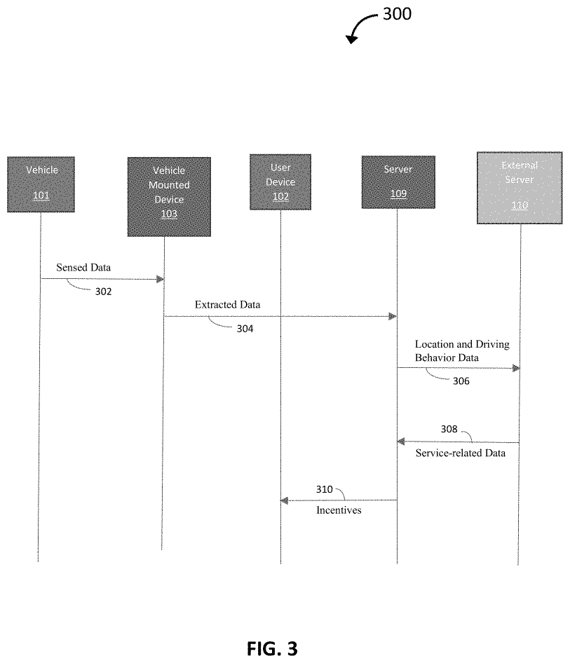

FIG. 3 illustrates a signal flow diagram for location and driving behavior-based incentive system in accordance with another embodiment. In FIG. 3, an exemplary signal flow diagram 300 is disclosed. FIG. 3 will be described in conjunction with terms and description used previously in FIGS. 1 and 2. The signal flow diagram 300 includes flow of data involving the vehicle 101, the vehicle mounted device 103, the user device 102, the server 109, and the external server 110.

In an embodiment, a user may download the app to purchase a service such as an auto insurance policy for the vehicle 101 associated with the user. In an embodiment, when the user downloads the app on the user device 102 and purchases the auto insurance policy, a vehicle mounted device 103 may be associated with the user. In an embodiment, the vehicle mounted device 103 may be shipped to the user who purchased the auto insurance policy. In an embodiment, the vehicle mounted device 103 may be a hardware device plugged into an OBD port of the vehicle 101 to sense vehicle related data such as location data and driving behavior data. In an embodiment, the vehicle mounted device 103 may be an OEM device. In an embodiment, the vehicle mounted device 103 may be a built-in hardware device inside the vehicle 101. In an embodiment, the vehicle mounted device 103 may be a read-only device.

At step 302, when the user drives the vehicle 101, the vehicle mounted device 103 present inside the vehicle 101 may sense or detect locations where the vehicle 101 is being driven as well as sense or detect driving behavior of the user driving the vehicle 101. In an embodiment, the vehicle mounted device 103 may constantly collect the location data and driving behavior data associated with the driver of the vehicle 101. In an embodiment, the vehicle mounted device 103 may store the location data and driving behavior data associated with the driver of the vehicle 101 temporarily for a predefined time period.

At step 304, the vehicle mounted device 103 may transmit the collected location data and driving behavior data to the server 109. In an embodiment, the vehicle mounted device 103 may transmit the collected location data and driving behavior data to the server 109 constantly or after every predetermined interval. In an embodiment, the server 109 may analyze the collected location data and the driving behavior data from the vehicle mounted device 103 to determine in real-time or non-real time whether the user being interacted with is a safe driver or not.

In an embodiment, the server 109 may determine incentives for the user associated with the vehicle 101 if the user is determined to be a safe driver based on the collected location data and driving behavior data from the vehicle mounted device 103. In an embodiment, the incentives may be one or more of coins, points, discount vouchers, and coupons. In an embodiment, the incentives may be used to redeem benefits related to Car Parking, Car Wash, Car Fuel filling, and other services on the app platform.

Steps 306, 308, and 310 of FIG. 3 are similar to steps 206, 208, and 210 explained previously in the description of FIG. 2.

FIG. 4 illustrates a block diagram of a server for location and driving behavior-based incentives in accordance with an embodiment. FIG. 4 will be explained in conjunction with the description provided above for FIGS. 1-3. In FIG. 4, block diagram of an exemplary server, such as server 109, is depicted. The server 109 may include a processor 402, memory 404, and communication interface 406.

The processor 402 may include suitable logic, circuitry, interfaces, and/or code that may be configured to execute a set of instructions stored in the memory 404. The processor 402 may be implemented based on a number of processor technologies known in the art. The processor 402 may include, but is not limited to, one or more digital processors, e.g., one or more microprocessors, microcontrollers, an X86-based processor, a Reduced Instruction Set Computer (RISC) processor, Advanced RISC Machine (ARM)-based processor, an Application-Specific Integrated Circuit (ASIC) processor, a Complex Instruction Set Computing (CISC) processor, Digital Signal Processors (DSPs), Field Programmable Gate Arrays (FPGAs), Complex Programmable Logic Devices (CPLDs), or any mix thereof.

The memory 404 may include suitable logic, circuitry, and/or interfaces that may be configured to store a machine code and/or a computer program with at least one code section executable by the processor 402. Examples of implementation of the memory 404 may include, but are not limited to, Random Access Memory (RAM), Read Only Memory (ROM), Flash memory, Hard Disk Drive (HDD), and/or other memories.

The memory 404 may include, but is not limited to, Rules Engine, Training Model, Scoring Module, Rating Generation Module, Behavior-based Risk Profile Data, User Profiles, Insurance Company Profiles (A . . . n), Authentication Module, Mapping Module, Driving Behavior Data, Incentive Determination Module, Location Module, Artificial Intelligence (AI) Module, and/or Machine Learning (ML) Module. Each of these modules may be capable of receiving and sending data to every other module.

In machine learning, a common task is the study and construction of algorithms that can learn from and make predictions on data. Such algorithms function by making data-driven predictions or decisions, through building a mathematical model from input data. These input data used to build the model are usually divided in multiple data sets. In particular, three data sets are commonly used in various stages of the creation of the model: training data set, validation data set, and test data sets.

The model is initially fit on a “training data set,” which is a set of examples used to fit the parameters of the model. The model is trained on the training data set using a supervised learning method. The model is run with the training data set and produces a result, which is then compared with a target, for each input vector in the training data set. Based at least on the result of the comparison and the specific learning algorithm being used, the parameters of the model are adjusted. The model fitting can include both variable selection and parameter estimation.

Successively, the fitted model is used to predict the responses for the observations in a second data set called the “validation data set.”

The server 109 may be part of a larger computer system and/or maybe operatively coupled to a computer network (a “network”) with the aid of a communication interface to facilitate the transmission of and sharing data and predictive results. The computer network may be a local area network, an intranet and/or extranet, an intranet and/or extranet that is in communication with the Internet, or the Internet. The computer network in some cases is a telecommunication and/or a data network, and may include one or more computer servers. The computer network, in some cases with the aid of a computer system, may implement a peer-to-peer network, which may enable devices coupled to the computer system to behave as a client or a server.

The server 109 also includes one or more I/O Managers as software instructions that may run on the one or more processors and implement various communication protocols such as User Datagram Protocol (UDP), MODBUS, MQTT, OPC UA, SECS/GEM, Profinet, or any other protocol, to access data in real-time from disparate data sources via any communication network, such as Ethernet, Wi-Fi, Universal Serial Bus (USB), ZIGBEE, Cellular or 5G connectivity, etc., or indirectly through a device's primary controller, through a Programmable Logic Controller (PLC) or through a Data Acquisition (DAQ) System, or any other such mechanism.

In accordance with the present disclosure, the notification and alerts are sounded by the server 109 are based on the identification of rare items, events or observations which raise suspicions by differing significantly from the baseline of the data. Predictive Analysis encompasses a variety of statistical techniques from data mining, predictive modelling, and machine learning, which analyze current and historical facts to make predictions about future or otherwise unknown events.

In accordance with an embodiment of the present disclosure, machine learning model training may happen at the edge, close to the data source, or on any remote computer. In certain embodiments, the mathematical representations of the machine learning model training details are stored in memory close to the source of input data. Disparate relevant data streams are fed in memory to a machine learning runtime engine running on the server 109 close to the data source in order to get low latency inferencing. Communication between the second server 109 and a client may be via a communication network such as local area network (LAN), a general wide area network (WAN), and/or a public network (e.g., the Internet, Wi-Fi, 5G) via network adapter etc.

In an embodiment, the Driving Behavior Data may include behavior data extracted from the module on the app of the user device 102 and/or the vehicle mounted device 103. In an embodiment, the Location module may compute and/or store the location data extracted from the module on the app of the user device 102 and/or the vehicle mounted device 103. In an embodiment, the Incentive Determination Module may be configured to determine the incentives applicable for each user based on the location data and the behavior data of each user. In an embodiment, the incentives may be one or more of coins, points, discount vouchers, and coupons for users who are determined to be safe or no-risk drivers with good driving behavior. In an embodiment, the incentives may be used to redeem benefits related to Car Parking, Car Wash, Car Fuel filling, and other services on the app platform.

The location and driving behavior-based incentive system may have multiple applications or uses. As an example, the location and driving behavior-based incentive system rewards the users determined to be safe drivers or exhibiting good driving behavior with incentives, thereby promoting safe driving among the drivers. Since the users with good driving behavior will be rewarded, there is a possibility that such users will be less prone to using fraudulent means to reduce their insurance premiums while signing up for insurance policies. As another example, the location and driving behavior-based incentive system may be beneficial for users to reduce premium of auto insurance policies due to their good driving behavior. This may be possible when the collected location data and the driving behavior data for the users are shared by the server 109 with the one or more insurance companies under an agreement. As yet another example, since the vehicle-related data sensed by the vehicle mounted device 103 is collected by the server 109 in real-time, the location and driving behavior-based incentive system may help the user in case of thefts and/or accidents by taking an appropriate action.

The terms “including,” and/or “includes,” and “having,” as used in the specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the location and driving behavior-based incentive system described herein contain optional features that can be individually or together applied to any other embodiment shown or contemplated here to be mixed and matched with the features of that system.

While the invention has been described with respect to a limited number of embodiments, those skilled in the art, having benefit of this disclosure, will appreciate that other embodiments can be devised which do not depart from the scope of the invention as disclosed herein.

I/We claim:

1. A method implemented in a behavior-based risk-profiling system, said method comprising:
receiving at least one of a location and a driving-behavior metric of a user;
determining a risk profile of the user by analyzing the received at least one of the location and the driving-behavior metric, wherein the risk profile indicates a risk associated with a driving behavior; and
classifying the user based on the determined risk profile.

2. The method of claim 1, further comprising incentivizing the user based on classifying the user, wherein the incentivizing comprises:
communicating at least one recommendation to the user based on the determined risk profile to improve the risk profile; and
incentivizing a compliance by the user with the at least one recommendation.

3. The method of claim 1, wherein determining the risk profile comprises:
training an artificial neural network (ANN) based on at least one of the gathered location and the at least one driving-behavior metric; and
implementing the ANN to predict the risk associated with the driving behavior of the at least one user.

4. The method of claim 1, wherein prior to the incentivizing, the method further comprises:
communicating the determined risk profile to a remote server; and
receiving a validation of the risk profile from the remote server, wherein the remote server is associated with a service provider maintaining at least one historical log of the user.

5. The method of claim 1, wherein the at least one location of the user comprises a plurality of Global Positioning System (GPS) coordinates at which a vehicle driven by the user is positioned.

6. The method of claim 1, wherein the at least one driving-behavior metric is received from at least one on-board sensor installed in a vehicle driven by the user, further wherein, the at least one driving-behavior metric comprises at least one of:
a driving behavior of the user, an alert state of the user, a frequency of over-speeding by the user, a frequency of abrupt acceleration by the user, a frequency of abrupt braking by the user, a frequency of driving upon uneven terrain by the user, and a frequency of driving upon an even terrain by the user.

7. The method of claim 2, wherein the compliance by the user with the at least one recommendation proposes to avail at least one service related to a plurality of automobile related services and a plurality of non-automobile related services from a corresponding service provider.

8. The method of claim 2, further comprising:
disincentivizing a non-compliance by the user with the at least one recommendation by alerting the user and a service provider.

9. A behavior-profiling system for evaluating a user, said system comprising:
a determination module configured to receive at least one of a location and a driving-behavior metric of a user;
an AI module configured to:
determine a risk profile of the user by analyzing the received at least one of the location and the driving-behavior metric, wherein the risk profile indicates a risk associated with a driving behavior; and
classify the user based on the determined risk profile.

10. The system of claim 9, further comprising an incentive module configured to incentivize the user based on the determined risk profile, wherein the incentive module is configured to:
communicate at least one recommendation to the user based on the determined risk profile to improve the risk profile; and
incentivize a compliance by the user with the at least one recommendation.

11. The system of claim 9, wherein the AI module is configured to:
train an artificial neural network (ANN) based on at least one of the gathered location and the at least one driving-behavior metric; and
implement the ANN to predict the risk associated with the driving behavior of the at least one user.

12. The system of claim 9, further comprising a mapping module configured to:
communicate the determined risk profile to a remote server; and
receive a validation of the profile from the remote server, wherein the remote server is associated with a service provider maintaining at least one historical log of the user.

13. The system of claim 9, wherein the determination module is configured to gather the at least one location of the user as a plurality of Global Positioning System (GPS) coordinates at which a vehicle driven by the user is positioned.

14. The system of claim 9, wherein the determination module is configured to receive the at least one driving-behavior metric from at least one on-board sensor installed in a vehicle driven by the user, further wherein, the at least one driving-behavior metric comprises at least one of:
a driving behavior of the user, an alert state of the user, a frequency of over-speeding by the user, a frequency of abrupt acceleration by the user, a frequency of abrupt braking by the user, a frequency of driving upon uneven terrain by the user, and a frequency of driving upon an even terrain by the user.

15. The system of claim 10, wherein the incentive module is configured to incentivize the compliance by the user with the at least one recommendation by proposing the user at least one service related to a plurality of automobile related services and a plurality of non-automobile related services from a corresponding service provider.

16. The system as claimed in claim 10, further comprising a disincentive module configured to disincentivize a non-compliance with the at least one recommendation by the user by alerting the user and a service provider.

17. A non-transitory computer-readable storage medium, having stored thereon a computer-executable program which, when executed by at least one processor, causes the at least one processor to:
receive at least one of a location and a driving-behavior metric of a user;
determine a risk profile of the user by analyzing the received at least one of the location and the driving-behavior metric, wherein the risk profile indicates a risk associated with a driving behavior; and
classify the user based on the determined risk profile.
